(19) United States
(12) Patent Application Publication
(10) Pub. No.: US 2025/0223209 A1
(43) Pub. Date: Jul. 10, 2025

(54) WATER TREATMENT SYSTEM WITH BIOCONTACTOR

(71) Applicant: DDP SPECIALTY ELECTRONIC MATERIALS US, LLC, Wilmington, DE (US)

(72) Inventors: Steven JONS, Edina, MN (US); Bin HE, Zhejiang (CN); Bie LI, Zhejiang (CN); Rami ABU AMIRAH, Windsor (AU); Bill CAI, Zhejiang (CN)

(21) Appl. No.: 18/850,794

(22) PCT Filed: Apr. 6, 2023
(86) PCT No.: PCT/US2023/017682

§ 371 Date: Sep. 25, 2024

(30) Foreign Application Priority Data
Apr. 15, 2022 (WO) PCT/CN2022/086955

(51) Int. Cl. C02F 3/10

(52) U.S. Cl. CPC C02F 3/102; C02F 2201/004; C02F 2201/006; C02F 2209/03; C02F 2301/02

(57) ABSTRACT

A water treatment system comprising a pressure vessel, vertically aligned separation elements within the vessel each having at least one porous UF or MF membrane, feed fluid passageways, a permeate fluid passageway, a concentrate removal port, and a biocontactor within the vessel that has biogrowth surfaces surrounding flow paths through the biocontactor. The flow paths have a median ratio of surface area to volume which exceeds 15 cm⁻¹. The pressure vessel also contains a pressure plate with holes which separates the vessel into two chambers, a first chamber containing membrane elements and a second chamber that contains the biocontactor. A sealing means contacting the pressure plate prevents fluid flow between the first chamber and second chamber except through the porous membranes.

### CROSS-REFERENCE TO RELATED APPLICATION

The present application claims priority under 35 U.S.C. § 365 (c) to PCT Intl. Appln. No. PCT/CN22/086955, filed on Apr. 15, 2022, which is incorporated herein in its entirety.

### BACKGROUND OF THE INVENTION

Several patents, patent applications and publications are cited in this description in order to more fully describe the state of the art to which this invention pertains. The entire disclosure of each of these patents, Patent Applications and publications is incorporated by reference herein.

A plurality of microfiltration (MF) and/or ultrafiltration (UF) elements is commonly employed within a pressure vessel. Through the application of pressure to one surface of the membrane, the semi-permeable membrane is able to separate a feed fluid into a treated permeate stream that passes through the membrane and a retentate stream that does not. A common element design comprises a plurality of hollow fiber membranes.

Biological treatment systems have been used for pretreatment of water prior to hyperfiltration. These systems typically remove constituents of water conducive to microbial growth such as nutrients, e.g., organic carbon, nitrate, phosphate, and oxygen, from the water to create an environment in the hyperfiltration modules that is inhospitable to microbial growth. In one design for a multi-element vessel for UF, described in JP10-28847A, an ion exchange layer is incorporated into a pressure vessel containing UF elements, but there is no description of a biological treatment unit. It is desired to provide an improved method of pretreating impure water, especially water to be further purified by hyperfiltration, especially reverse osmosis or nanofiltration.

### SUMMARY OF THE INVENTION

The present invention is directed to a water treatment system 2 comprising:
a pressure vessel 10 with a removable lid 12 and a plurality of distinct ports, said distinct ports comprising a feed introduction port 14, a concentrate removal port 16, a treated-water removal port 18, and a cleaning fluid port 20;
a plurality of vertically aligned separation elements 30 within the vessel 10, said separation elements 30 each comprising at least one porous membrane 32 selected from the group consisting of a microfiltration membrane and an ultrafiltration membrane; first 34 and second 36 feed fluid passageways that connect the feed-side surface 38 of the membrane 32 to regions outside the element 30, and a permeate fluid passageway 40 that is in fluid communication with the permeate-side surface 42 of the membrane 32; wherein at least the first feed fluid passageway 34 is in communication with the concentrate removal port 16 and at least the second feed fluid passageway 36 is in communication with either the feed introduction port 14 or an optional coarse filter 44 that is itself in fluid communication with the feed introduction port 14;
a permeate collection region 78 within the vessel in fluid communication with the cleaning fluid port 20 and a plurality of permeate fluid passageways 40;
a biocontactor 50 within the vessel, wherein the biocontactor 50 comprises a plurality of biogrowth surfaces 52 surrounding flow paths 54 through the biocontactor that connect an entry region 56 of the biocontactor 50 to an exit region 58 of the biocontactor 50, wherein the entry region 56 of the biocontactor 50 is connected to the permeate fluid passageway 40 of multiple separation elements 30 through the permeate collection region 78, and the exit region 58 is connected to the treated-water removal port 18; and wherein the flow paths 54 through the biocontactor have a median ratio of surface area to volume which exceeds 15 cm⁻¹, and
a pressure plate 70 containing holes 72 therethrough, wherein the pressure plate 70 separates the vessel into two chambers (74, 76), a first chamber 74 that contains the majority portion 46 of each aligned membrane element 30 and a second chamber 76 that contains the biocontactor 50 and the permeate collection region 78, wherein said holes 72 enable fluid flow from the permeate fluid passageways 40 of said membrane elements 30 to the entry region 56 of said biocontactor 50; and wherein a sealing means 80′ contacting said pressure plate 70 prevents fluid flow between the first chamber 74 and second chamber 76 except through said porous membranes 32.

The present invention is further directed to a process of operating the water treatment system 2, wherein valves 28 are connected to each of the feed introduction port 14, the concentrate removal port 16, the treated-water removal port 18, and the cleaning fluid port 20; and said valves are alternately positioned to enable operation in a water-treatment mode, in a membrane chemical-cleaning mode, and in a biocontactor cleaning mode; and
wherein the water-treatment mode is characterized by a treatment flow path that enables sequential convective flow a) through the feed introduction port 14, b) through the plurality of separation elements 30, c) through the permeate collection region 78, d) through the biocontactor 50, and e) through the treated-water removal port 18.

The advantages and features of novelty that characterize the invention are pointed out with particularity in the claims annexed hereto and forming a part hereof. For a better understanding of the invention, its advantages, and the objects obtained by its use, however, reference should be made to the drawings which form a further part hereof, and to the accompanying descriptive matter, in which there is illustrated and described one or more preferred embodiments of the invention.

### BRIEF DESCRIPTION OF THE DRAWINGS

FIGS. 1-3 are cross sections of three different embodiments of the water treatment system.

FIGS. 4a and 4b are partial cutaway views illustrating a removable cartridge before and after loading of particulate media within.

FIG. 5 is an exploded view of components within a vessel that are arranged to provide a downward flow of permeate through the biogrowth region of a biocontactor.

FIGS. 6a and 6b illustrate cross sections of different spiral wound biocontactors, corresponding to embodiments rolled without and with a central tube.

FIGS. 6c and 6d are perspective views of two embodiments of a spiral wound biocontactor.

FIG. 7 illustrates a water treatment system comprising a plurality of parallel vessels and a hyperfiltration system.

FIG. 8 is a cross-section of a portion of the biocontactor 50.

### DETAILED DESCRIPTION OF THE INVENTION

The water treatment system includes a pressure vessel that contains both multiple elements in a filtration stage and a biocontactor. A pressure vessel preferably has a cylindrical shape. Preferably the ends of the cylindrical shape are domes of the types commonly encountered in pressure vessels. The biocontactor is suitable to remove easily assimilable nutrients from the water. Preferably, the biocontactor is detachable from the vessel to facilitate replacement. Preferably, resistance to flow within the biocontactor results in a pressure drop across the biocontactor of less than 1 bar (101 kPa), when provided with a flow of 25° C. water into the biocontactor at a volumetric rate equivalent to 4 cm/sec times the cross-sectional area of the vessel. Preferably, the biocontactor comprises a spiral-wound flat sheet and spacer material, wherein the flat sheet has two opposing biogrowth surfaces and the spacer material provides flow paths between the biogrowth surfaces, the flow paths extending from the biocontactor entry region to the exit region. Preferably, the biocontactor comprises particulate media that form the biogrowth surface and flow paths are the void between particles. Preferably the particles are resin beads. Preferably, the biocontactor has a horizontal cross-sectional area that exceeds the horizontal cross-sectional area of each separation element by a factor of at least 25. Preferably, the biocontactor has a width of at least one meter, preferably no more than four meters. The term “majority portion” means at least 50% of the total volume, preferably at least 75%.

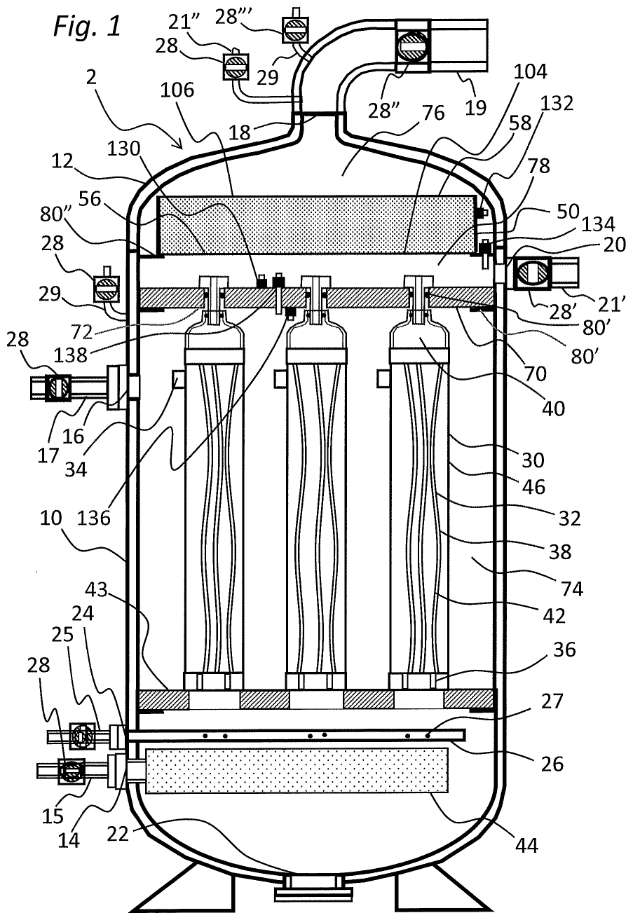

Referring now to the drawings, wherein like reference numerals designate corresponding structure throughout the views, and referring in particular to FIGS. 1-3, multiple embodiments of an inventive water treatment system 2 comprise a pressure vessel 10 with a removable lid 12. The pressure vessel 10 is preferably cylindrical and vertically oriented. The lid 12 serving to open and close the vessel 10 is preferably on the top of the vessel 10, although it may also be on the bottom of the vessel 10. The vessel has several distinct ports. A feed introduction port 14 is connected to a feed line 15 that supplies water to be treated. A concentrate removal port 16 is connected to a concentrate line 17 for discharging untreated liquid. A treated-water removal port 18 is connected to the treated-water line 19 for supplying treated water to downstream operations. Optionally, a first cleaning fluid line 21′ may be connected to a cleaning fluid port 20. Preferably, a discharge port 22 near the bottom of the vessel is present for removing settled waste from the vessel. Preferably, one or more air introduction ports 24 connect to air introduction lines 25 to enable air scouring, such as through an air distributor 26. Preferably, an air removal line 29 connected near an upper accumulation point is used to bleed air from the vessel, such as after a pressure-hold test. In addition, there may be other cleaning fluid lines 21″ in communication with the vessel through valves, for supply and/or discharge of cleaning fluids. Valves 28 external to the vessel may enable a port to serve multiple purposes. For example, in FIG. 1, the treated water removal port 18 connects the vessel 10 to the treated water removal line 19 outside the vessel 10, but the port 18 is also connected to an air removal line 29 and flow therethrough is regulated by its own valve 28″.

Within the vessel 10, there are a plurality of vertically aligned membrane elements 30, with the membrane elements each comprising at least one porous membrane 32 that is either a microfiltration or an ultrafiltration membrane. Microfiltration membranes have pore sizes that are between 0.2 μm to 10 μm. Ultrafiltration membranes have smaller pores, between about 0.002 μm and 0.2 μm. Most preferred membranes used in this approach have a mean flow pore size between about 0.02 μm and about 0.1 μm. Membranes within each element 30 may be in flat sheet or hollow fiber form, and each has a feed-side surface 38 which contacts the solution to be filtered and a permeate-side surface 42 through which the filtered solution passes. The membrane element 30 also includes a first feed fluid passageway 34 that connects feed-side surfaces 38 of the membranes 32 to the concentrate removal port 16. The membrane element 30 includes a second feed fluid passageway 36 that connects the feed-side surfaces 38 to either the feed introduction port 14 or to an optional coarse filter 44 that is itself in fluid communication with the feed introduction port 14. Finally, each membrane element 30 includes a permeate fluid passageway 40 that is in fluid communication with the permeate-side surface 42 of the membrane 32. In some embodiments, membrane elements 30 may rest on an optional lower support structure 43, such as a porous plate, horizontal beams, or pedestal. In other embodiments, the position of membrane elements 30 may be maintained by connections with the pressure plate 70. The portions of first chamber 74 that are on either side of the support structure 43 may be sealed from each other. Preferably, however, the portions of first chamber 74 that are on either side of the support structure 43 are in fluid communication, as support structure 43 is porous, discontinuous, or otherwise permeable to liquid. Some suitable support structures 43 are described in Intl. Patent Appln. Publn. No. WO2022240460, for example.

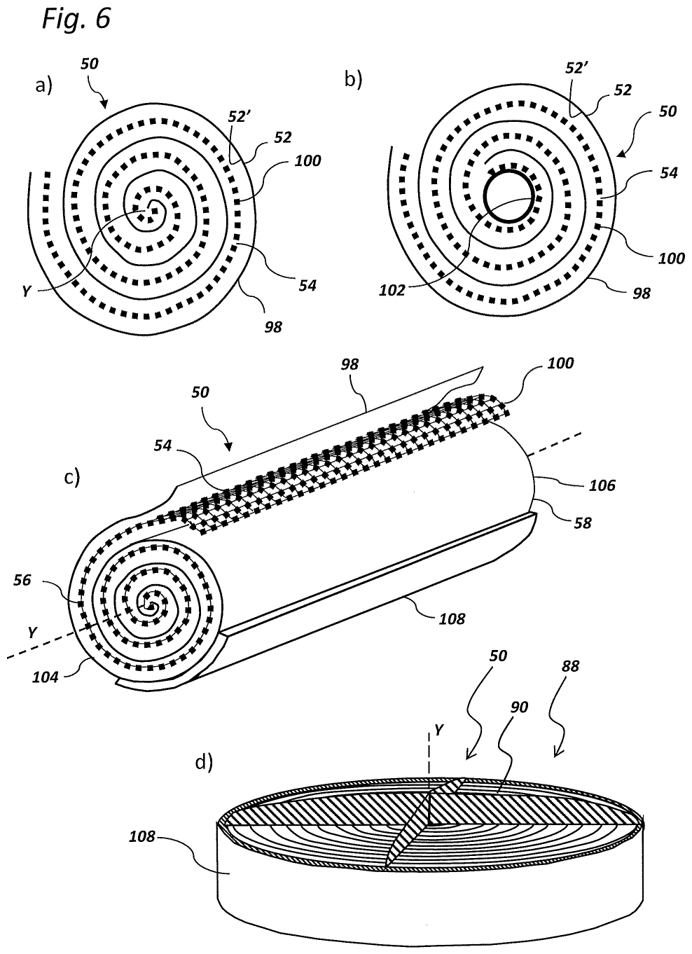

There is a biocontactor 50 within the vessel that facilitates controlled growth of a biofilm. The biocontactor 50 may be attached in operation to the vessel lid 12 or to a portion of the vessel 10 below the lid 12. The biocontactor is preferably detachable from the vessel to facilitate replacement if necessary, and it may be exchanged with a different biocontactor after removal of the lid 12 from the vessel 10. The biocontactor 50 comprises a plurality of biogrowth surfaces 52 (FIG. 6) surrounding flow paths 54 through the biocontactor that connect an entry region 56 of the biocontactor 50 to an exit region 58 of the biocontactor 50. The flow paths 54 through the biocontactor 50 have a median ratio of surface area to volume which exceeds 15 cm⁻¹, or more preferably even 30 cm⁻¹, or even more preferably 50 cm⁻¹. The resistance to flow within the biocontactor preferably results in a pressure drop across a clean biocontactor at 25° C. of less than 1 bar, more preferably less than 0.5 bar, and even more preferably less than 0.2 bar, when provided a water flow rate into the biocontactor 50 equivalent to 4 cm/sec multiplied by the cross sectional area of the vessel 10. (For example, with a 200 cm diameter cylindrical vessel 10, the relevant pressure drop across the biocontactor 50 for this purpose would be assessed using a water flow of 31.4 L/see at 25° C.)

Referring once more to FIGS. 1 to 3, pressure plate 70 containing holes 72 separates the pressure vessel 10 into two chambers (74, 76), a first chamber 74 that contains the majority portion 46 of each aligned membrane element 30 and a second chamber 76 that contains the biocontactor 50 and the permeate collection region 78. Holes 72 in the pressure plate 70 enable fluid flow from the permeate fluid passageways 40 of the membrane elements 30 to the entry region 56 of the biocontactor 50. A sealing means 80′, including one or more o-rings or gaskets, for example, contacts the pressure plate 70 and prevents fluid flow between the first chamber 74 and second chamber 76, except when it passes through the porous membranes 32.

During production of treated water, permeate flows from the plurality of vertically aligned membrane elements 30 and passes through the biocontactor 50 on its way to the treated-water removal port 18. A permeate collection region 78 within the second chamber 76 is in fluid communication with the entry region 56 of the biocontactor, with a plurality of permeate fluid passageways 40, and with the cleaning fluid port 20. Hence, the entry region 56 of the biocontactor 50 is connected to the permeate fluid passageway 40 of multiple membrane elements 30 through the permeate collection region 78. The exit region 58 of the biocontactor is connected to the treated-water removal port 18.

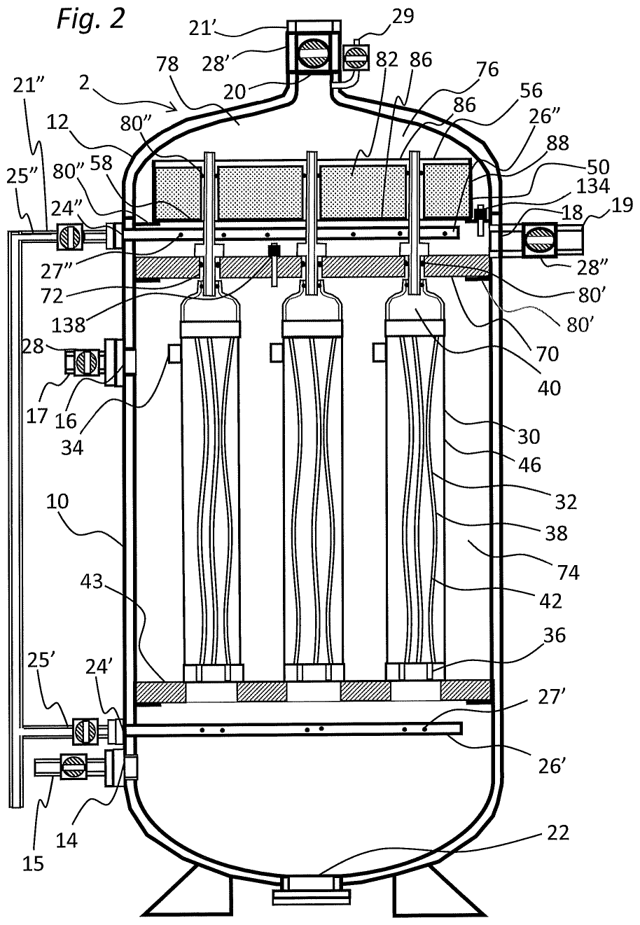

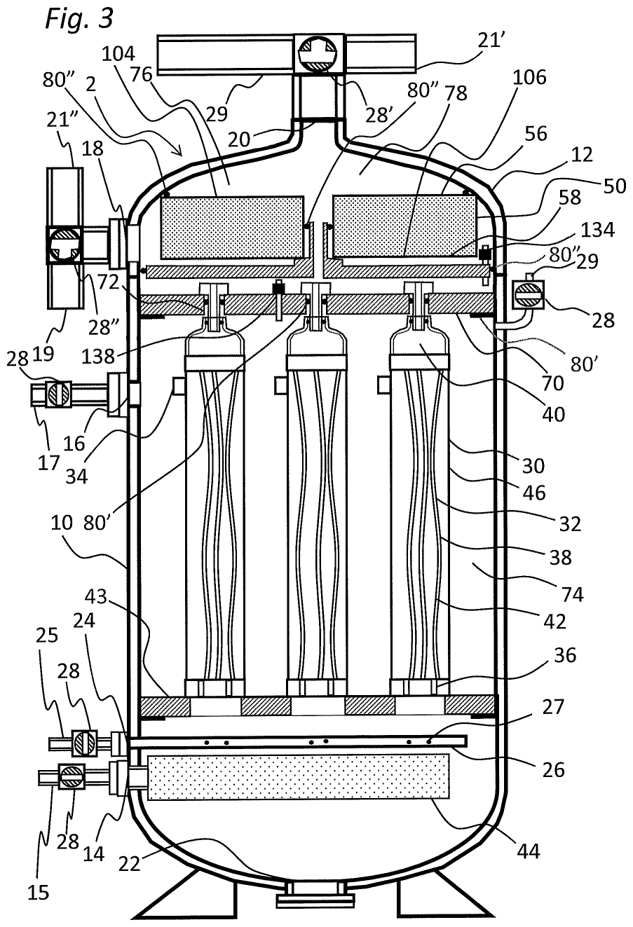

In preferred embodiments, the biocontactor 50 is located within the vessel 10 and above the membrane elements 30. In some embodiments, a majority (by volume) of the biocontactor 50 is laterally surrounded by the removable lid 12. As shown in FIG. 1, the entry region 56 of the biocontactor 50 may be positioned below the exit region 58 of the biocontactor 50. However, FIGS. 2 and 3 illustrate embodiments where the exit region 58 is below the entrance entry region 56. In FIGS. 1-3, there are conduits connecting the permeate fluid passageway 40 of membrane elements 30 to the permeate collection region 78. In FIG. 2, those conduits pass through holes 72 in the pressure plate 70 and extend through the biocontactor 50 to enable an upward flow path that bypasses biogrowth surfaces 52 within the biocontactor 50 and a downward flow path that traverses across the biogrowth surfaces 52. In FIG. 3, a central conduit connected to the permeate fluid passageways 40 of membrane elements 30 also allows for an upward flow path that initially bypasses the biogrowth surfaces 52. A second sealing means 80″, including one or more o-rings or gaskets, for example, eliminates a bypass for direct permeate passage between the permeate collection region 78 and the treated-water removal port 18, forcing permeate from separation elements 30 to flow through the biocontactor 50 and across biogrowth surfaces 52. One less preferred embodiment that enables a downward flow path that traverses across biogrowth surfaces 52 would include a conduit outside the vessel that connects the permeate fluid passageway 40 of elements to a region above the biocontactor 50. In other embodiments (not shown), the pressure plate may be located below the membrane elements, resulting in a pressurized first chamber being above the lower-pressure second chamber. For instance, permeate may be taken from the lower end of membrane elements, pass through a hole in the pressure plate, and then enter the upper end of a biocontactor within the lower chamber. This geometry also enables a generally downward flow through flow paths through the biocontactor, from an upper entry region to lower exit region. One advantage of a downward flow of permeate through biogrowth surfaces 52 is that bubbles from an air distributor 26 below the biocontactor 50 can be effectively used to detach biofilm from biogrowth surfaces 52 within the biocontactor 50.

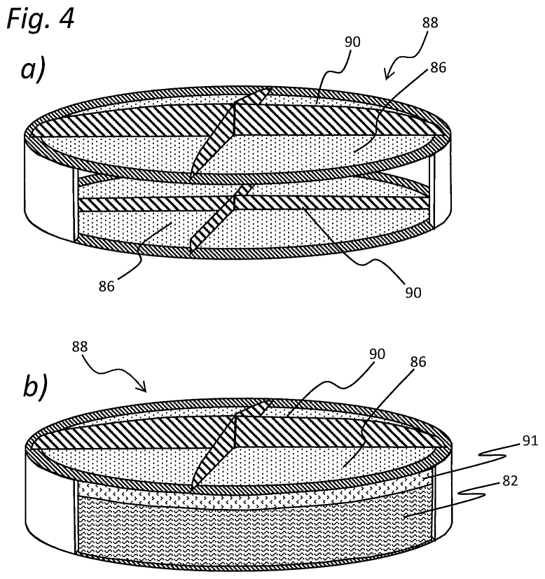

The biocontactor 50 is suitable to treat fluid from multiple membrane elements 30. Preferably, the cross-sectional area of the biocontactor 50 is at least 10 times greater (more preferably at least 25 times greater or at least 50 times greater) than the cross-sectional area of any one membrane element. Preferably, the biocontactor is at least twice as wide as it is tall. Preferably, the ratio of the smallest width of the biocontactor to the height of the biocontactor is more than 2, and preferably more than 4. The biocontactor is preferably less than 0.5 meters tall. For a biocontactor spanning more than one meter in width, support ribs 90 (FIG. 4) are preferably positioned on the top and/or bottom to allow the biocontactor 50 to be flushed in both directions while maintaining a differential pressure of at least 1 bar.

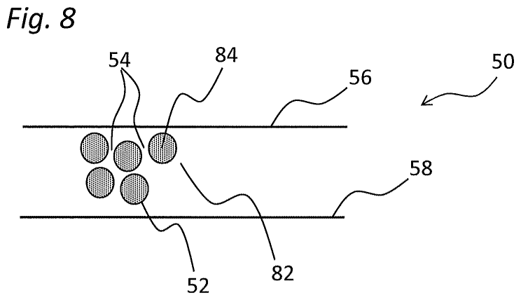

Referring to FIG. 8, in one embodiment, the biocontactor 50 comprises particulate media 82 that forms the biogrowth surfaces 52 on which biofilm forms. The flow paths 54 between particles 84 connect an entry region 56 of the biocontactor 50 to an exit region 58 of the biocontactor 50. In this case, the majority (by volume) of particles 84 within biocontactor preferably have a dimension between 50 microns and 2 mm, more preferably between 200 and 700 microns. Preferably, the particles 84 are spherical resin beads, as these pack well and predictably. The particles may be of more than one type, and a preferred embodiment uses particles of different densities so that layered beds are formed by gravity. In some embodiments, one type of particle sinks in water and one type of particle floats. Screens 86 adjacent the entry region 56 and exit region 58 are sized to prevent passage of these particles.

Preferably, the biocontactor 50 is a removable cartridge 88 that contains a particulate media 82. FIGS. 4a and 4b illustrate such a removable cartridge 88, before and after loading of particulate media 82. The removable cartridge 88 may include support ribs 90 that strengthen it for both movement and replacement and for operation under pressure. Alternatively, support structures (e.g., ribs or plates) may be built into the vessel structure, including into the lid 12. In some embodiments, the biocontactor 50 containing particulate media 82 may comprise a plurality of smaller cartridges, making them easier to move. In a preferred embodiment, the cartridge 88 comprises particulate media 82 that fill not more than 90% of cartridge volume, so that a head space 91 comprises at least 10% of the of volume of the cartridge 88 and enables movement of the particulate media 82 in the presence of at least one of water flow or air flow.

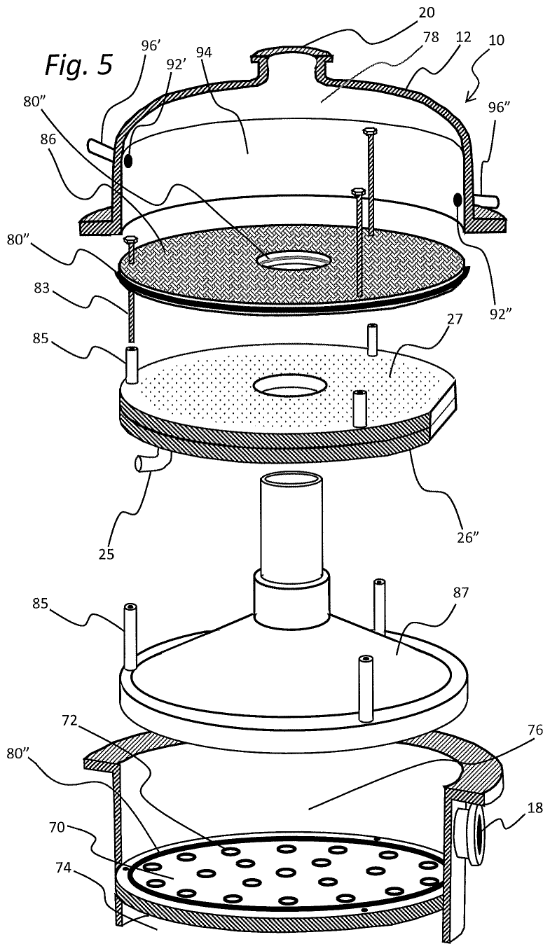

As an alternative to a removable cartridge 88 that contains a particulate media 82, the media may be removed from the vessel 10 via vacuum suction or as suspended particulates within a liquid flush. FIG. 5 shows an exploded view of the top end of a pressure vessel 10 suitable to contain loose particulate media. While the particulate media is not shown in FIG. 5, it intended to be located within the vessel, between the lid 12 and a screen 86, wherein the screen 86 has hole size suitable to prevent passage of particulate media. To aid in the removing of particles, one or more media ports 92 on the vessel 10 may be connected to a media containment region 94 holding particles within the second chamber 76. In the embodiment depicted in FIG. 5, one media conduit 96′ connected to a media port 92′ is configured to align off-center and directs fluid entering the vessel into a spiraling flow that washes particles from the sides of the media containment region 94. Optionally, an additional media conduit 96″ and media port 92″ may be located below the majority of media 82 in the media containment region 94, so that particles are able to flow under gravity from the media containment region 94 upon opening a valve. The two described potential locations of the media ports (92′, 92″) are complementary, so that both may advantageously be present in the vessel 10 for addition and removal of particulates.

When the vessel 10 illustrated in FIG. 5 is assembled, the manifold 87, air distributor 26″, and screen 86 are fixed at specific locations within the vessel by removable connectors 83 (e.g. screws, magnets, ties, and the like). In the embodiment of FIG. 5, spacers 85 are utilized to maintain fixed distances between parts. The figure also shows multiple second sealing means 80″ that force permeate from separation elements 30 to flow through the biocontactor 50 and across biogrowth surfaces 52, eliminating bypass between the permeate collection region 78 and the treated-water removal port 18.

In other embodiments, the biocontactor 50 may be in a spiral wound configuration, as illustrated in FIGS. 6a-d. A flat sheet 98 and spacer material 100 may be wound about in a spiral to make a cylindrical form of similar diameter to the vessel 10, preferably within 10% of the vessel diameter. The spacer material 100 provides flow paths 54 between adjacent flat sheets 98 to enable fluid flow from the entry region 56 at a first end surface 104 to the exit region 58 at an opposing second end surface 106 of the cylindrical form. Closer spacing of the adjacent flat sheets 98 in the spiral configuration provides a greater number of biogrowth surfaces 52 in the same volume, but at the cost of increased pressure drop and increased difficulty in cleaning. In some cases, winding may be performed about a central rod or tube 102 to facilitate construction. The hollow tube 102 can also provide an alternative path for fluid flow between a first end surface 104 and a second end surface 106 of the spiral wound biocontactor, enabling fluid to avoid in that pass the flow paths 54 adjacent biogrowth surfaces 52. This can facilitate a change in flow direction through the biocontactor 50, such as was desired for the vessel configurations of FIGS. 2, 3, and 5. The outer periphery of each bioreactor 50 is preferably cylindrical and may include an outer shell 108, as illustrated in FIGS. 6c and 6d.

In forming a spiral wound biocontactor, the type of spacer material is not particularly limited. It may be a sheet of extruded net, such as is commonly used for the feed spacer in spiral wound membrane elements. It may be a Tricot knit, as is often used for the permeate spacer in spiral wound elements. It may be dots or lines of adhesive applied to the flat sheet that prevent tight winding. It may be indentations formed in the flat sheet itself, so that adjacent sheets remain separated upon winding. Representative examples of spiral wound membrane elements are described in U.S. Pat. Nos. 8,991,027, 8,142,588 and 6,881,336, for example.

Still referring to FIGS. 6a-d, the flat sheet 98 to be used in a biocontactor 50 has two opposing bio-growth surfaces 52, but is not particularly limited. It may be formed from any of several different polymers including polyethylene, polypropylene, nylon, and polyester. It may be non-porous (e.g., impermeable) or porous. (Porous surfaces are preferred, as these can better retain small sections of biofilm despite cleanings, so that re-growth is facilitated. However, for the purpose of calculating surface area to volume, a flat surface is assumed, such that a 0.5 mm distance between adjacent flat sheets corresponds to a 40 cm⁻¹ ratio.)

In a preferred embodiment, the biocontactor 50 is formed using only one continuous flat sheet 98 and adjacent spacer material 100, as compared to the multiple membrane sheets commonly employed in making spiral wound elements for UF, nanofiltration (NF), and reverse osmosis (RO). Preferred embodiments are depicted in FIGS. 6a, 6b, and 6c, for example.

Preferably, the average distance between adjacent surfaces of wound flat sheet 98 is at least more than, and preferably at least twice, the thickness of the flat sheet. Preferably, the void volume between bio-growth surfaces 52 is at least 50% of the volume of the bioreactor, more preferably at least 65% of the volume of the bioreactor.

A biocontactor 50 having a spiral wound configuration can telescope under a differential pressure, and the issue is particularly relevant when the diameter (width of biocontactor) is larger than its axial length (height). In some cases, adhesive may be applied intermittently between adjacent sheets, to strengthen the spiral configuration and prevent telescoping under pressure. Support structures (e.g., ribs or plates) may be provided on either or both ends of the spiral wound biocontactor. FIG. 6d illustrates ribs 90 on an upper surface of the biocontactor. As depicted, the width (diameter) of the illustrated spiral biocontactor 50 is more than four times the height (in the axial Y direction).

In the system 2 described herein, the biocontactor 50 receives permeate water from one or more membrane elements 30 within the same vessel 10. Among other advantages, this arrangement allows the biocontactor to avoid clogging and to have smaller channels and more surface area for biogrowth than if it were directly treating the feed water supplied to the vessel. A large portion of assimilable organic carbon (AOC) can also be removed first in the membrane elements, thereby extending the working range of the biocontactor 50 without cleaning. Similarly, in some embodiments, water from the feed introduction port 14 can be first treated by an optional coarse filter 44 that may be located within or outside of the vessel, downstream or upstream of the port 14, before allowing the feed to flow into the membrane elements 30. Preferably, the coarse filter 44 is located within the vessel to make a compact system. Preferably, the coarse filter 44 has a size cut-off (defined as the size for which less than 90% of the particles are retained), which is smaller than the average distance between adjacent biogrowth surfaces 52 in the biocontactor 50. Removing larger particles prior to membranes can be particularly advantageous for spiral wound biocontactors, as damaged membranes (e.g., broken fibers) can otherwise allow passage of particles that could clog channels in the biocontactor 50.

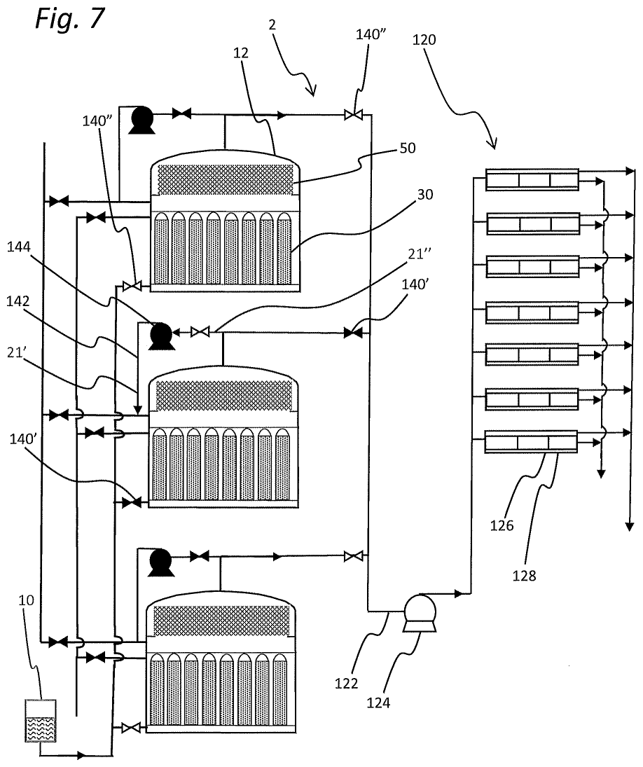

Preferably, as shown in FIG. 7, the water treatment system includes a downstream hyperfiltration system 120 comprising at least one pump and a plurality of pressure housings containing reverse osmosis or nanofiltration modules. Preferably, the treated-water removal port 18 is connected to the inlet 122 of a pump 124 supplying treated-water from the biocontactor 50 to a plurality of downstream housings 126 containing hyperfiltration modules 128. More preferably, multiple similar pressure vessels 10 containing biocontactors 50 are operated in parallel to feed the hyperfiltration system 120, so that each may be periodically removed from service for cleaning. In this way, the biocontactor 50 and hyperfiltration system 120 may be connected directly, without a buffering storage tank. In some embodiments, a subsequent pressure vessel comprising a phosphate selective resin (not shown) may be located between the biocontactor 50 and the hyperfiltration system 120.

Referring once more to FIG. 1, it is intended that the biocontactor 50 will be cleaned periodically. Determining appropriate cleaning times for the biocontactor can be best done by measuring the differential pressure drop across the biocontactor 50, between the entry region 56 and the exit region 58. With both the biocontactor 50 and membrane elements 30 in series, one or more pressure sensors (130, 132, 136) that respond to a pressure between the two units is desired. Preferably, a pressure sensor 130 is responsive to pressure in the permeate collection region 78 and (in conjunction with another appropriately positioned sensor 132 within the vessel) is suitable to be used in measuring pressure drop across the biocontactor 50. Most preferably, a differential pressure sensor 134 is responsive to the pressure in the permeate collection region 78 and a region fluidly connected to the exit region 58, and the differential pressure sensor 134 is suitable to measure pressure drop across the biocontactor 50. Hence, either two pressure sensors (130, 132) or one differential pressure sensor 134 may be configured to be suitable to measure pressure drop across the biocontactor 50. Similarly, it is preferred that one or more pressure sensors (130, 136) are responsive to measure pressure in the permeate collection region 78 and suitable to be used in measuring pressure drop across the membrane elements 30. Most preferably, a differential pressure sensor 138 is suitable to measure pressure drop across the pressure plate 70. In practice, a sensor (not shown) placed within a permeate fluid passageway 40 or within the cleaning fluid port 20 can still be responsive to the pressure in the permeate collection region 78. In conjunction with a second pressure sensor (132, 136) located near the exit region 58 of the biocontactor 50 or in the first chamber 74, a pressure sensor 130 responsive to the pressure in the permeate collection region 78 would likely be suitable to measure differential pressure across the biocontactor 50 or membrane elements 30, respectively. One or more pressure sensors installed in nearby locations are suitable to measure pressure drop across the biocontactor 50 or membrane elements 30, respectively, if their response is directionally the same and if pressure drops between actually compared locations differ by less than 10% from those across the biocontactor 50 or membrane elements 30.

In FIGS. 1-3, the entry region 56 of the biocontactor is connected to a first cleaning fluid line 21′ through the cleaning fluid port 20. The exit region 58 of the biocontactor may be connected to a second cleaning fluid line 21″ in addition to the treated water line 19. Both cleaning fluid lines (21′, 21″) may be used to enable introduction of cleaning fluids or removal of dislodged particulates. In FIG. 2, the cleaning fluid supplied by the second cleaning fluid line 21″ may be a gas such as air, for example, and the resulting bubbles flow upward from holes 27″ in an air distributor 26″. Thus, biogrowth is scrubbed from the biogrowth surfaces 52 in the biocontactor 50. In that case, dislodged material may be removed through a first cleaning fluid line 21′ connected to the entry region 56 of the biocontactor. FIG. 3 illustrates a different approach, wherein a chemical cleaner (for example, without limitation, acid, base, chlorine, or enzymes) may be passed through the biocontactor 50, which is located between the first cleaning fluid line 21′ and the second cleaning fluid line 21″. (A valve 28″ selects between the treated-water line 19 and the second cleaning fluid line 21″.) In this embodiment, the liquid cleaning fluid may be recirculated in multiple passes through the biocontactor 50, with a recirculation loop (not shown) that includes a recirculation cleaning fluid pump (not shown), the first and second cleaning lines (21′, 21″), and the biocontactor 50. The recirculation cleaning fluid pump may also be configured with lines and valves to enable a recirculating flow of liquid cleaning fluid through multiple biocontactors 50 in a plurality of parallel vessels 10, each having internal parts as described above.

During periods of cleaning the biocontactor 50 or membrane elements 30, treated water from the vessel 10 is not supplied to downstream operations. Valves and pumps are required to appropriately direct fluids into, out of, and within the vessel 10, so that undesired contamination is avoided in the membrane elements 30, the biocontactor 50, or the downstream hyperfiltration system 120. For instance, a preferred cleaning method for membrane elements 30 is to distribute chemicals (caustic and/or chlorine, e.g.) into the permeate side 38 of the membranes 32, perhaps daily, but high levels of these chemicals are generally incompatible with maintaining an active biofilm within the biocontactor 50. Hence, a preferred embodiment (not shown) would arrange valves to substantially prevent fluid flow of the chemical cleaning solution into the biocontactor 50. As another example, it is sometimes necessary to remove biofilm from the biocontactor 50, such as by air scouring or by chemical cleaning. In this mode of operation (not shown), it is important that valves in the system be configured to direct flow to avoid passing the removed biofilm into either the permeate-side 38 of membrane elements 30 or into the hyperfiltration system 120. Similarly, it can be advantageous to inoculate a recently cleaned biocontactor 50 to support rapid biogrowth, and the inoculant should not pass through the membrane elements 30 or into the hyperfiltration system 120. In this case, it is preferred that a valve 28′ enable flow through a port 21′ connected to a location between the permeate fluid passageway 40 and the entry region 56 of the biocontactor 50.

With reference to FIGS. 1-3, the table below describes several suitable operating conditions for the water treatment system described herein.

TABLE I

| | |
|---|---|
| Production | The water treatment systems illustrated in FIGS. 1, 2, and 3 show connected valves |
| of treated | 28 suitable to allow or prevent flow through each of the feed introduction port |
| water | 14, the concentrate removal port 16, the treated-water removal port 18 and the |
| | cleaning fluid port 20. In each case, valves 28 are oriented to illustrate the |
| | dominant water-treatment mode, where a continuous flow of feed water enters |
| | the vessel 10 through the feed introduction port 14 and exits the vessel as treated |
| | water through the treated-water removal port 18. During this production of |
| | treated water, fluid flows in parallel through multiple membrane separation |
| | elements 30 and the permeate from these membrane elements 30 is further |
| | passed through a biocontactor 50 before it exits the vessel 10. FIGS. 1 and 3 |
| | further illustrate an optional coarse filter 44 located between the feed |
| | introduction port 14 and the second feed fluid passageway 36 of each membrane |
| | separation element 30. |
| Forward- | Cleaning chemicals are supplied from outside the vessel 10 and caused to flow |
| flush with | across the feed-side surface 38 of the membrane 32. In one embodiment, |
| chemical- | chemicals are introduced by flowing between the feed introduction port 14 and |
| cleaning of | concentrate removal port 16, with the corresponding valves 28 for those ports |
| membrane | being open. Permeate is not produced during this chemical cleaning, so the valve |
| elements | 28″ between the treated-water removal port 18 and the treated water removal |
| | line 19 is preferably closed. |
| Permeate | During a permeate backflush, water is pushed through the membrane 32 in |
| backflush of | reverse, from the permeate-side surface 42 of a membrane to the feed-side |
| membrane | surface 38 of the membrane. It is not desirable to simply reverse flow within the |
| elements | vessel 10 from the path typically used for producing treated water, since this |
| | could force biogrowth from the biocontactor 50 into the permeate-side of |
| | membranes. Instead, it is preferred to provide fluid from a port 20 between the |
| | permeate collection region 78 and the entry region 56 of the biocontactor 50. |
| | More preferably, the valve 28′ connected to the cleaning fluid port 20 is open to |
| | enable fluid flow into the permeate collection region 78 and through the porous |
| | membrane 32. |
| Chemically | Cleaning chemicals are supplied from outside the vessel 10 and caused to flow |
| enhanced | backwards from the permeate-side surface 42 of membrane to the feed-side |
| backwash of | surface 38 of the membrane. In this chemical cleaning mode, cleaning chemicals |
| membrane | (especially base or chlorine) are preferably introduced by flowing from the |
| elements | cleaning fluid port 20, into the permeate collection region 78, and then further |
| | into the permeate fluid passageway 40 of multiple membrane separation |
| | elements 30. A valve 28′ connected to the cleaning fluid port 20 is open to enable |
| | flow through the cleaning fluid port 20. Preferably, a valve 28″ connected to the |
| | treated-water removal port 18 is closed to prevent flow through that port 18 and |
| | through the biocontactor 50. The cleaning chemicals may be removed through a |
| | concentrate removal port 16. |
| Air scouring | Another approach to cleaning membranes is air scouring. In this approach air is |
| of | introduced from below the membrane elements 30, such as through an air |
| membranes | distributor 26, and foulants are removed via the concentrate removal port 16. Air |
| elements | is removed through line 29, as described above. In some cases, air scouring may |
| | be performed while flowing through the biocontactor 50 and producing treated |
| | water, so the valve 28″ connected to the treated water removal port 18 may |
| | optionally be open. |
| Reversal of | Biogrowth within the biocontactor 50 is essential for the removal of nutrients; |
| flow | however, biogrowth accumulation will increase pressure drop across this |
| direction | component. Reversing the direction of flow within the biocontactor can |
| through | encourage removal of biogrowth, but the removed biofilm should not enter the |
| biocontactor | permeate collection region 78 of membrane elements 30. Accordingly, during the |
| | reversal of flow through the biocontactor, a valve 28′ connected to the cleaning |
| | fluid port 20 is open to enable flow from the vessel 10 through the cleaning fluid |
| | port 20. At the same time, valves 28 connected with the first chamber 74 are |
| | preferably closed to inhibit discharge from the biocontactor 50 from entering the |
| | permeate collection region 78 and the membrane elements 30. |
| Air scouring | FIGS. 2 and 5 show an air distributor below the biocontactor 50. If air scouring |
| of | is used to clean the biocontactor 50, it is preferred to release discharged waste |
| biocontactor | from the biocontactor to the cleaning fluid port 20 and to a connected cleaning |
| | fluid line 21′. Release may be done subsequent to the air scouring step but before |
| | re-entering the water treatment mode. |
| Chemical | The biocontactor cleaning mode may include chemically cleaning the |
| cleaning of | biocontactor, especially with chlorine or caustic. Chemical cleaning can reduce |
| biocontactor | the differential pressure within the biocontactor 50. In one preferred approach, a |
| | valve 28′ connected to the cleaning fluid port 20 is open, and a cleaning fluid |
| | passes between the entry region 56 and exit region 58 of the biocontactor 50. |
| | Valves 28 connected to ports (14, 16) in the first chamber 74 may be closed to |
| | prevent chemicals (and biofilm removed from the biocontactor) from entering |
| | membranes 32 through the permeate. In an alternative approach the |
| | biocontactor 50 and the membrane separation elements 30 may be cleaned at |
| | the same time, for example by passing cleaning fluid between the entry region 56 |
| | and exit region 58 as described above with at least one valve 28 on and the valve |
| | 28′ closed. The chemical cleaning of the biocontactor may be shorter or less |
| | intense (lower concentration or temperature) than conditions used to clean the |
| | membranes. |
| Inoculation | Operation of the water-treatment system 2 may include a step of inoculating the |
| of the | biocontactor 50 with a bacteria laden solution. This can have particular |
| biocontactor | advantage subsequent to installing a new biocontactor, subsequent to re- |
| | installing a removed and cleaned biocontactor, or subsequent to chemically |
| | cleaning a biocontactor within the vessel 10. In a preferred embodiment, the |
| | bacteria laden solution contains bacteria previously removed from a biocontactor, |
| | especially via air scouring or reversal of flow within the biocontactor. While |
| | inoculation is not itself a cleaning step, it can reduce the time to return to efficient |
| | operation after a biocontactor cleaning mode that uses caustic or chlorine. In |
| | preferred embodiments, the bacteria laden solution is introduced to the |
| | biocontactor through the permeate collection region 78. It is further preferred |
| | that the bacteria laden solution flows into the permeate collection region 78 |
| | through the cleaning fluid port 20. |

During operation of the water-treatment system, valves are most commonly positioned to enable a water-treatment mode. Referring to FIG. 1, in this mode, a valve 28′ connected to the cleaning fluid port 20 is closed to prevent flow through the cleaning fluid port 20, and other valves 28 are positioned to create a treatment flow path that enables sequential convective flow:
a) through the feed introduction port 14,
b) optionally through a coarse filter 44,
c) through a plurality of separation elements 30, passing in each case through the second feed fluid passageway 36, through at least one porous membrane 32, and through a permeate fluid passageway 40,
d) through the permeate collection region 78,
e) through the biocontactor 50, passing in each case across biogrowth surfaces 52 from an entry region 56 to an exit region 58,
f) and through the treated-water removal port 18.

In a preferred embodiment, for example as depicted in FIG. 3, fluid flows across the biogrowth surfaces 52 of the biocontactor 50 in a generally downward flow path during this water-treatment mode.

Referring once more to FIGS. 1, 2, and 3, operation further includes a membrane chemical-cleaning mode wherein valves are positioned to enable flow of a cleaning fluid containing chlorine or caustic, for example, through the membrane separation elements 30 and to restrict flow of the cleaning fluid through the biocontactor 50. In this mode, a valve 28′ connected to the cleaning fluid port 20 is preferably opened to enable flow through the cleaning fluid port 20 and into the permeate fluid passageway 40, and a valve 28″ connected to the treated-water removal port 18 is preferably closed to prevent flow through that port 18 and through the biocontactor 50.

Still referring to FIGS. 1, 2, and 3, operation further includes a biocontactor cleaning mode, wherein valves are positioned to enable a cleaning fluid to flow through the biocontactor 50. In the biocontactor cleaning mode, particles dislodged from the biocontactor 50 are prevented from entering the membrane separation elements 30. In a preferred embodiment depicted in FIG. 7, treated-water from the biocontactor 50 is supplied to downstream hyperfiltration modules 128 during the water-treatment mode and flow that passes through the biocontactor 50 is prevented from flowing to the hyperfiltration modules 128 during the biocontactor cleaning mode. FIG. 7 illustrates valves (140′, 140″) that may be positioned to isolate the biocontactor being cleaned. In the central position, valves (140′) are positioned so that a pump 144 and recirculation loop 142 directs fluid through the biocontactor. In one embodiment, the cleaning fluid passing through the biocontactor 50 contains chlorine or caustic. In another embodiment, the cleaning fluid passing through the biocontactor 50 comprises air or other gas bubbles. In a preferred embodiment, the direction of fluid flow through the biocontactor 50 is opposite during the water-treatment mode and the bioreactor cleaning mode.

In some preferred embodiments, the biocontactor 50 is periodically cleaned by air scouring. As illustrated in FIG. 2, separate air distributors (26′, 26″) with holes (27′, 27″) may be present below both the membrane elements 30 and the biocontactor 50. Air introduction lines (25′, 25″) are shown connected to individual air introduction ports (24′, 24″) and to the air distributors (26′, 26″). Preferably, a common source of pressurized gas supplies the air introduction lines (25′, 25″) associated with air distributors (26′, 26″) below the membrane elements 30 and the biocontactor 50. The air or other gas may be released through air removal line 29.

In some preferred embodiments, the biocontactor 50 is periodically cleaned by passing a cleaning fluid through it, where the cleaning fluid is preferably chlorine (e.g., sodium hypochlorite or other hypochlorites) or caustic (hydroxide salts, preferably sodium hydroxide or potassium hydroxide). In some preferred embodiments, a common cleaning fluid port 20 is used to provide chemicals that are used in both cleaning the membrane elements 30 and cleaning the biocontactor 50. In FIG. 7, valves (140′, 140″) are shown positioned to enable the middle biocontactor to be taken off-line for cleaning while continuing operation of others. The liquid cleaning fluid may be recirculated in multiple passes through the biocontactor 50, with a recirculation loop 142 that includes a recirculation cleaning fluid pump 144.

While certain of the preferred embodiments of the present invention have been described and specifically exemplified above, it is not intended that the invention be limited to such embodiments. Rather, it is to be understood that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

1. A water treatment system 2 comprising:
a pressure vessel 10 with a removable lid 12 and a plurality of distinct ports, said distinct ports comprising a feed introduction port 14, a concentrate removal port 16, a treated-water removal port 18, and a cleaning fluid port 20;
a plurality of vertically aligned separation elements 30 within the vessel 10, said separation elements 30 each comprising at least one porous membrane 32 selected from the group consisting of a microfiltration membrane and an ultrafiltration membrane; first 34 and second 36 feed fluid passageways that connect the feed-side surface 38 of the membrane 32 to regions that are within the vessel 10 and outside the element 30, and a permeate fluid passageway 40 that is in fluid communication with the permeate-side surface 42 of the membrane 32; wherein at least the first feed fluid passageway 34 is in communication with the concentrate removal port 16 and at least the second feed fluid passageway 36 is in communication with the feed introduction port 14;
a permeate collection region 78 within the vessel in fluid communication with the cleaning fluid port 20 and a plurality of permeate fluid passageways 40;
a biocontactor 50 within the vessel, wherein the biocontactor 50 comprises a plurality of biogrowth surfaces 52 surrounding flow paths 54 through the biocontactor that connect an entry region 56 of the biocontactor 50 to an exit region 58 of the biocontactor 50, wherein the entry region 56 of the biocontactor 50 is connected to the permeate fluid passageway 40 of multiple separation elements 30 through the permeate collection region 78, and the exit region 58 is connected to the treated-water removal port 18; and wherein the flow paths 54 through the biocontactor have a median ratio of surface area to volume which exceeds 15 cm⁻¹, and
a pressure plate 70 containing holes 72 therethrough, wherein the pressure plate 70 separates the vessel into two chambers (74, 76), a first chamber 74 that contains the majority portion 46 of each aligned membrane element 30 and a second chamber 76 that contains the biocontactor 50 and the permeate collection region 78, wherein said holes 72 enable fluid flow from the permeate fluid passageways 40 of said membrane elements 30 to the entry region 56 of said biocontactor 50; and wherein a sealing means 80′ contacting said pressure plate 70 prevents fluid flow between the first chamber 74 and second chamber 76 except through said porous membranes 32.

2. The water treatment system of claim 1, wherein the biocontactor 50 is detachable from the vessel 10 and may be exchanged with a different biocontactor after removal of the lid 12 from the vessel 10.

3. The water treatment system of claim 1, wherein the resistance to flow within the biocontactor 50 results in a pressure drop of less than 1 bar, when provided a flow of 25° C. water into the biocontactor 50 at a volumetric rate equivalent to 4 cm/sec multiplied by the cross-sectional area of the vessel 10.

4. The water treatment system of claim 1 further comprising a pressure sensor responsive to pressure in the permeate collection region 78 and configured in the vessel to be used in measuring pressure drop across the biocontactor 50.

5. The water treatment system of claim 1 wherein the biocontactor 50 is in a spiral wound configuration formed of multiple windings of a flat sheet 98 and spacer material 100; wherein the flat sheet 98 has two opposing bio-growth surfaces 52 and the spacer material 100 provides flow paths 54 between the biogrowth surfaces 52, extending from the entry region 56 to the exit region 58.

6. The water treatment system of claim 1 wherein the biocontactor 50 comprises particulate media 82 that form the biogrowth surfaces 52 and flow paths 54 between particles 84.

7. The water treatment system of claim 6, wherein the particulate media 82 is contained within a removable cartridge 88.

8. The water treatment system of claim 1, wherein the biocontactor 50 has a horizontal cross-sectional area that exceeds the horizontal cross-sectional area of each separation element by a factor of at least 25.

9. The water treatment system of claim 1, wherein the biocontactor 50 is more than a meter in width and has support ribs 90 on the top or bottom surface that allow it to be flushed in both directions while maintaining a differential pressure of at least 1 bar.

10. A process of operating the water treatment system of claim 1, wherein valves 28 are connected to each of the feed introduction port 14, the concentrate removal port 16, the treated-water removal port 18, and the cleaning fluid port 20; and said valves 28 may be positioned to enable operation in a water-treatment mode, in a membrane chemical-cleaning mode, and in a biocontactor cleaning mode; and
wherein the water-treatment mode is characterized by a treatment flow path that enables sequential convective flow a) through the feed introduction port 14, b) through the plurality of separation elements 30, c) through the permeate collection region 78, d) through the biocontactor 50, and e) through the treated-water removal port 18.

11. The process of claim 10 wherein the biocontactor cleaning mode is practiced with valves 28 positioned to provide a flow of air or liquid through the biocontactor 50 to dislodge particulates, and to prevent the discharged particulates from contacting membranes 32.

12. The process of claim 11 wherein the liquid is a cleaning fluid comprising a chemical selected from chlorine and caustic, and the membrane chemical-cleaning mode is practiced with valves 28 positioned to prevent flow of the cleaning fluid through the biocontactor 50, and to enable flow of cleaning fluid either
a) across the feed-side surface 38 of the membrane 32, between first 34 and second 36 feed fluid passageways, or
b) through the membrane 32 from the permeate-side surface 42 to the feed-side surface 38.

13. The process of claim 12 wherein the biocontactor cleaning mode employs a flow of cleaning chemicals through the cleaning fluid port 20.

14. The process of claim 12, wherein the water-treatment mode includes a flow path that traverses across the biogrowth surfaces 52 in a downward direction.

15. The water treatment system of claim 1, wherein the feed introduction port 14 is equipped with a coarse filter 44 that prevents particles in the feed from entering the interior of the vessel 10.
